(19) United States
(12) Patent Application Publication
(10) Pub. No.: US 2017/0163124 A1
(43) Pub. Date: Jun. 8, 2017

(54) POWER GENERATION APPARATUS USING HEAD OF WASTEWATER IN BUILDING

(71) Applicants: KB TECHNOLOGY CO., LTD., Gyeonggi-do (KR); SHINHAN UNIVERSITY R & DB FOUNDATION, Gyeonggi-do (KR)

(72) Inventors: Dong-hwa BAEK, Gyeonggi-do (KR); Hyun-soo PARK, Seoul (KR)

(21) Appl. No.: 15/325,629

(22) PCT Filed: May 29, 2015
(86) PCT No.: PCT/KR2015/005402

§ 371 Date: Jan. 11, 2017

(30) Foreign Application Priority Data
Jul. 15, 2014 (KR) 10-2014-0088881

(51) Int. Cl. H02K 7/18; F03B 17/02; F03B 13/06

(52) U.S. Cl. CPC H02K 7/1823; F03B 13/06; F03B 17/02

(57) ABSTRACT

A power generation apparatus using a head of wastewater in a building includes an inclined water discharge pipe connected to an end of a wastewater pipe installed in the building through one end thereof, to divert a moving path of wastewater falling through the wastewater pipe, a cavity part coupled to the other end of the inclined water discharge pipe, to receive the wastewater discharged through the other end of the inclined water discharge pipe, and a rotating body installed inside of the cavity part, to be rotated by the wastewater discharged through the other end of the inclined water discharge pipe. Power is generated using a head of wastewater generated in a high-rise building or an apartment, and electricity generated using the wastewater is used as common electricity inside/outside the building. Therefore, smooth power supply can be achieved.

### TECHNICAL FIELD

The present invention relates to a power generation apparatus using a head of wastewater in a building, and more particularly, to a power generation apparatus using a head of wastewater in a building, which may generate power using the head of wastewater generated in a high-rise building or an apartment, and use electricity generated using the wastewater as common electricity inside/outside the building to achieve reliable power supply.

### BACKGROUND ART

Generally, in order to generate energy, nuclear power generation using mass-defect energy generated at the time of nuclear fission reaction of uranium, plutonium, or the like, thermal power generation generating energy by combusting fuel such as heavy oil, coal, liquefied natural gas (LNG), or the like, and wind power generation generating power by rotating a windmill using kinetic energy of wind to rotate a waterwheel of a generator, are used. A high-rise building or an apartment is supplied with electricity from the power generation facilities as described above through a power transmission line.

However, the above-mentioned power generation method has problems as follows: the nuclear power generation has high risk of leakage of radioactivity, the thermal power generation currently causes exhaustion of energy and environmental pollution due to exhaust gas, and the wind power generation is not suitable for Korea in which changes in a wind direction and a wind speed severely occur due to geographical reason. When electricity is supplied from the power generation facilities through the power transmission line, power loss is severe due to long-distance power transmission, all facility costs and maintenance costs required for the power generation facilities are large, and power transmission towers or electricity cables installed everywhere for power transmission spoil the urban landscape.

Therefore, recently, solar power generation generating power by absorbing solar radiant heat energy and operating a heat engine and a generator is used in the high-rise building or the apartment, or a small hydropower generation apparatus is installed in the high-rise building or the apartment and a house to be supplied with electrical energy. However, there are various problems that efficiency of the solar power generation is drastically decreased, or an operation thereof is impossible on a cloudy day or a rainy day, and the small hydropower generation apparatus is impractical due to an insignificant amount of the generated energy.

### DISCLOSURE

### Technical Problem

Accordingly, it is an object of the present invention to provide a power generation apparatus using a head of wastewater in a building, which may generate power using a head of wastewater generated in a high-rise building or an apartment, and use electricity generated using the wastewater as common electricity inside/outside the building to achieve reliable power supply.

### Technical Solution

In order to achieve the above object, according to the present invention, there is provided a power generation apparatus using a head of wastewater in a building, including: an inclined water discharge pipe which is connected to an end of a wastewater pipe installed in the building through one end thereof, so as to divert a moving path of wastewater falling through the wastewater pipe; a cavity part which is coupled to the other end of the inclined water discharge pipe, so as to receive the wastewater discharged through the other end of the inclined water discharge pipe; and a rotating body which is installed inside of the cavity part, so as to be rotated by the wastewater discharged through the other end of the inclined water discharge pipe.

Preferably, the inclined water discharge pipe includes a spiral transfer pipe installed therein, into which the wastewater falling through the wastewater pipe is introduced.

In addition, the power generation apparatus may further include: a vertical water discharge pipe which is connected to a lower portion of the cavity part, through which the wastewater hitting the rotating body is discharged.

Further the rotating body may be rotated by the wastewater spurted through the spiral transfer pipe.

Further, the rotating body may have a rotating shaft which is rotated by rotation thereof and protrude to an outside of the cavity part.

### Advantageous Effects

According to the present invention, power is generated using a head of wastewater generated in a high-rise building or an apartment, and electricity generated using the wastewater is used as common electricity inside/outside the building. Therefore, reliable power supply can be achieved.

### DESCRIPTION OF DRAWINGS

FIG. 1 is a cross-sectional view illustrating a structure of a power generation apparatus using a head of wastewater in a building according to an embodiment of the present invention.

FIG. 2 is a perspective view illustrating a structure of an inclined water discharge pipe in the power generation apparatus using a head of wastewater in a building according to the embodiment of the present invention.

FIG. 3 is a perspective view illustrating a structure of an inclined water discharge pipe in a power generation apparatus using a head of wastewater in a building according to another embodiment of the present invention.

### BEST MODE

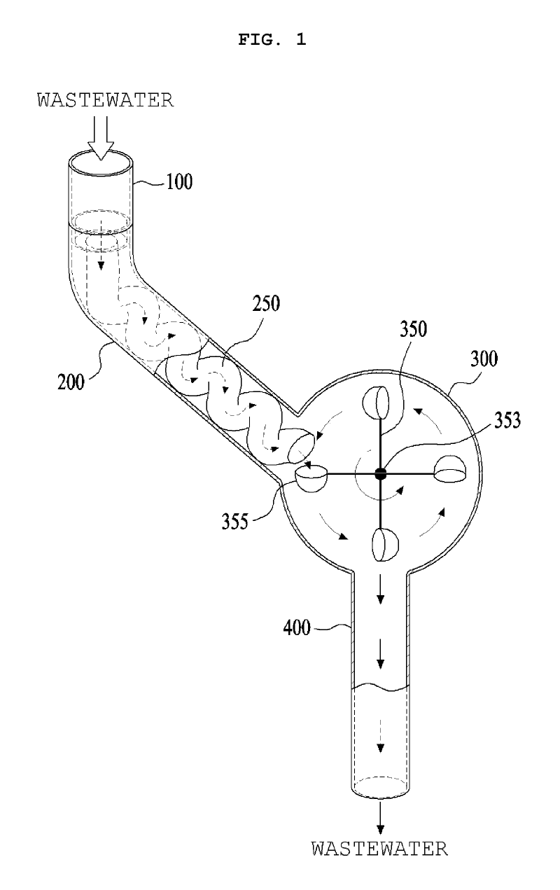

FIG. 1 is a cross-sectional view illustrating a structure of a power generation apparatus using a head of wastewater in a building according to an embodiment of the present invention. Referring to FIG. 1, the power generation apparatus using a head of wastewater in a building according to the embodiment of the present invention includes an inclined water discharge pipe 200, a cavity part 300, and a vertical water discharge pipe 400.

The inclined water discharge pipe 200 is a pipe fastened to a lower end portion of a wastewater pipe 100 vertically installed in the building, and functions to induce wastewater vertically falling through the wastewater pipe 100 to be discharged while forming a slope of approximately 75° with respect to the ground.

That is, an operator cuts a middle of the wastewater pipe 100 vertically installed in the building, and couples the inclined water discharge pipe 200 thereto as illustrated in FIG. 1, so as to divert a moving path of wastewater vertically falling through the wastewater pipe 100.

The cavity part 300 is coupled to a lower end of the inclined water discharge pipe 200 and serves as a space receiving the wastewater slantly moving and discharged through the inclined water discharge pipe 200. Specifically, the cavity part 300 includes a rotating body 350 installed therein, which is rotated by the wastewater discharged through the inclined water discharge pipe 200.

Meanwhile, the rotating body 350 has a plurality of hit parts 355 radially installed so as to rotate about a rotating shaft 353 thereof. The wastewater discharged through the inclined water discharge pipe 200 sequentially hits the plurality of hit parts, such that the rotating body 350 is rotated about the rotating shaft 350. Thereby, a kinetic energy of the wastewater is converted into a rotational energy of the rotating body 350.

In practicing the present invention, it is preferable that the hit part 355 is manufactured in a ladle shape, a bowl shape, or a hemispherical shape. By doing so, the wastewater hitting the hit part 355 may be filled in the hit part 355 such that the kinetic energy is transferred to the rotating body 350 by the hit at the time of spurt of the wastewater to rotate the rotating body 350, and the rotating body 350 may be rotated by a potential energy by a weight of the wastewater filled in the hit part 355 formed in a bowl shape after the hit of the wastewater.

As such, the rotating body 350 is applied with a strong rotational force by the kinetic energy by the sequential hit to the plurality of hit parts 355 and the potential energy by the weight of the wastewater filled in the hit part 355.

It is preferable that the cavity part 300 in which the rotating body 350 is installed is manufactured in a spherical shape or a cylindrical shape so that the rotating body 350 may be smoothly rotated, and may also be manufactured so as to be integrally formed with the inclined water discharge pipe 200.

Meanwhile, it is preferable that the rotating shaft 353 provided in the rotating body 350 is installed so as to penetrate through the cavity part 300 and to be rotated together with the rotating body 350 according to the rotation thereof. Accordingly, the operator couples a separate power generation apparatus or a power storage apparatus (not illustrated) to a portion of the rotating shaft 353 protruding to the outside of the cavity part 300, such that energy generated by the rotation of the rotating body 350 rotating in the cavity part 300 may be converted into an electrical energy through the power generation apparatus installed outside the cavity part 300.

Further, in the present invention, since the power generation apparatus and the power storage apparatus are installed outside the cavity part 300 as described above, these apparatuses are not exposed to the wastewater, and there is no need to expose the wastewater to the outside for power generation using the wastewater.

Meanwhile, the vertical water discharge pipe 400 is connected to a lower portion of the cavity part 300, and the wastewater falling downward in the cavity part 300 after rotating the rotating body 350 by hitting the rotating body 350 in an inner space of the cavity part 300 is discharged to a sewer pipe outside the building through the vertical water discharge pipe 400.

As such, in the present invention, the wastewater is discharged to the inside of the cavity part 300 in a state in which the wastewater dispersedly falling through the wastewater pipe 100 is concentrated by using the inclined water discharge pipe 200, thereby maximizing the rotational force of the rotating body 350.

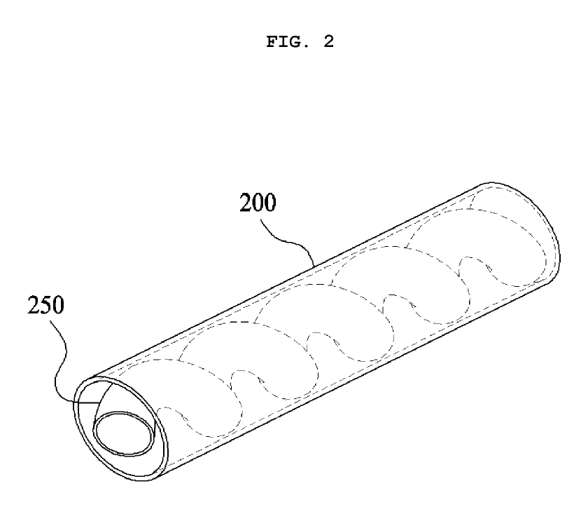

Further, in practicing the present invention, a spiral transfer pipe 250 may be separately installed in the inclined water discharge pipe 200 as illustrated in FIGS. 1 and 2. In this case, the wastewater introduced into the spiral transfer pipe 250 in the inclined water discharge pipe 200 is rotated and accelerated while passing through the spiral transfer pipe 250, thereby having higher kinetic energy than the case of without the same at the time of discharge to the cavity part 300.

Further, in practicing the present invention, the spiral transfer pipe 250 is configured so as to have a diameter of ½ to ⅔ of a diameter of the inclined water discharge pipe 200, such that the spiral transfer pipe 250 may be easily installed in the inclined water discharge pipe 200, as well as, an amount of wastewater directly introduced into the inclined water discharge pipe 200 but not introduced into the spiral transfer pipe 250 among the wastewater falling from the wastewater pipe 100 may be minimized.

Further, when the wastewater pipe 100 is not vertically installed in the building, but is slightly slantly installed, the wastewater is transferred along an inner wall of the wastewater pipe 100. Therefore, in practicing the present invention, it is preferable that an end of the spiral transfer pipe 250 on the wastewater pipe 100 side is installed so as to contact the inner wall of the wastewater pipe 100, thereby maximizing an amount of the wastewater introduced into the spiral transfer pipe 250 from the wastewater pipe 100.

As such, the wastewater spurted from the spiral transfer pipe 250 in a state of having high kinetic energy may transfer higher kinetic energy to the hit part 355, and in practicing the present invention, it is preferable that a discharge end of the spiral transfer pipe 250 and the hit part 355 formed in a bowl shape have the same size as each other, thereby further increasing transfer efficiency of the kinetic energy.

In addition, in practicing the present invention, spiral grooves having the same shape as each other may be formed in an inner surface of the spiral transfer pipe 250 in FIG. 2, thereby further increasing an effect of increasing the kinetic energy resulting from rotation and acceleration of the wastewater.

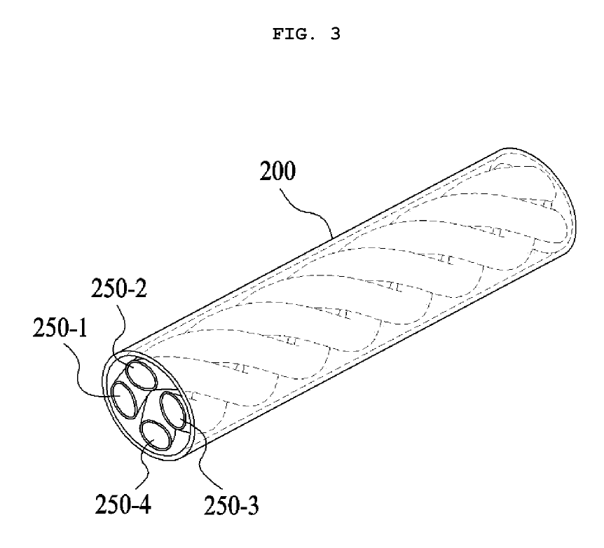

FIG. 3 is a perspective view illustrating a structure of an inclined water discharge pipe in a power generation apparatus using a head of wastewater in a building according to another embodiment of the present invention. Referring to FIG. 3, a plurality of spiral transfer pipes 250-1, 250-2 and . . . are installed in the inclined water discharge pipe in a power generation apparatus using a head of wastewater in a building according to another embodiment of the present invention. The plurality of spiral transfer pipes 250-1, 250-2 and . . . may secure an independent wastewater transfer path, respectively. That is, the plurality of spiral transfer pipes 250-1, 250-2, . . . are installed in the inclined water discharge pipe while being twisted like a “stranded steel cable”, and the wastewater introduced into the inclined water discharge pipe may be branched and discharged through the respective spiral transfer pipes 250-1, 250-2 and . . . . Therefore, the kinetic energy of the wastewater discharged from the inclined water discharge pipe and the rotational force of the rotating body 350 resulting from the kinetic energy may be maximized.

Terms used in the present invention are for the purpose of describing specific embodiments only, but are not intended to limit the present invention. A singular form includes a plural form unless the context clearly indicates otherwise. Throughout this specification, it will be understood that the term “comprise” and variations thereof, such as “comprising” and “having”, specify the presence of features, numbers, steps, operations, components, parts, or combinations thereof, described in the specification, but do not preclude the presence or addition of one or more other features, numbers, steps, operations, components, parts, or combinations thereof.

Although preferred embodiments and applications of the present invention have been described above, the present invention should not be construed as being limited to the above described specific embodiments and applications, but may be variously modified and embodied by a person having ordinary skill in the art to which the present invention pertains without departing from the gist of the present invention claimed in the appended claims. Such modifications should not be considered as departing from the technical idea or scope of the present invention.

### INDUSTRIAL APPLICABILITY

The present invention is applicable in the power generation industrial field.

1. A power generation apparatus using a head of wastewater in a building, comprising:
an inclined water discharge pipe which is connected to an end of a wastewater pipe installed in the building through one end thereof, to divert a moving path of wastewater falling through the wastewater pipe;
a cavity part which is coupled to the other end of the inclined water discharge pipe, to receive the wastewater discharged through the other end of the inclined water discharge pipe; and
a rotating body which is installed inside of the cavity part, to be rotated by the wastewater discharged through the other end of the inclined water discharge pipe.

2. The power generation apparatus using a head of wastewater in a building of claim 1, wherein the inclined water discharge pipe includes a spiral transfer pipe installed therein, into which the wastewater falling through the wastewater pipe is introduced.

3. The power generation apparatus using a head of wastewater in a building of claim 1, further comprising: a vertical water discharge pipe which is connected to a lower portion of the cavity part, through which the wastewater hitting the rotating body is discharged.

4. The power generation apparatus using a head of wastewater in a building of claim 2, wherein the rotating body is rotated by the wastewater spurted through the spiral transfer pipe.

5. The power generation apparatus using a head of wastewater in a building of claim 1, wherein the rotating body has a rotating shaft which is rotated by rotation thereof and protrude to an outside of the cavity part.
